(19) United States
(12) Patent Application Publication
(10) Pub. No.: US 2010/0081453 A1
(43) Pub. Date: Apr. 1, 2010

(54) MOBILE TERMINAL LOCATION BASED SERVICE SYSTEM AND METHOD FOR USING THE SAME

(75) Inventor: YU-CHUN CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/504,784

(22) Filed: Jul. 17, 2009

(30) Foreign Application Priority Data
Sep. 26, 2008 (CN) 200810304702.3

(51) Int. Cl. H04W 64/00; H04M 1/00

(52) U.S. Cl. 455/456.1; 455/550.1

(57) ABSTRACT

A mobile terminal location based service (LBS) system includes at least one mobile unit installed in a mobile terminal and at least one service unit installed in a cell base station of a wireless communicating network and wirelessly communicating with the mobile unit. The service unit stores data of mobile terminals communicating with the base station. When the mobile unit sends inquiry signals to the service unit to inquiry data of mobile terminals communicating with the base station, the service unit locates the inquired mobile terminals and sends data of the inquired mobile terminals to the mobile unit as LBS information.

### BACKGROUND

1. Technical Field

The present disclosure relates to mobile terminal Location Based Service (LBS) systems and methods for using the same, and particularly to a mobile terminal LBS system allowing the mobile terminals to query data of each other and a method for using the same.

2. Description of Related Art

Nowadays, mobile terminal Location Based Service (LBS) systems are widely used. A mobile terminal in a communication network using a mobile terminal LBS system can be located by two or more base stations of the communication network and be provided with many services. For example, current location information of the mobile terminal itself, weather and navigation information, as well as warnings of nearby dangers can be all provided to the mobile terminal. The data can be sent to the mobile terminal by different means, e.g., short messages, audio signals, e-mails, etc.

However, in most conventional mobile terminal LBS systems, the mobile terminals cannot receive any information regarding other mobile terminals from the base stations of the wireless communication networks. The conventional mobile terminal LBS systems cannot provide a user of a mobile terminal with a location of another mobile terminal or other information about the user of another mobile terminal.

Therefore, there is room for improvement within the art.

### BRIEF DESCRIPTION OF THE DRAWINGS

Many aspects of the present mobile terminal LBS system and method for using the same can be better understood with reference to the following drawings. The components in the various drawings are not necessarily drawn to scale, the emphasis instead being placed upon clearly illustrating the principles of the present mobile terminal LBS system and method for using the same. Moreover, in the drawings, like reference numerals designate corresponding parts throughout the figures.

FIG. 1 is a block diagram of a mobile terminal LBS system, according to an exemplary embodiment.

FIG. 2 is a flow chart of a mobile terminal locating and service providing method, according to an exemplary embodiment.

### DETAILED DESCRIPTION

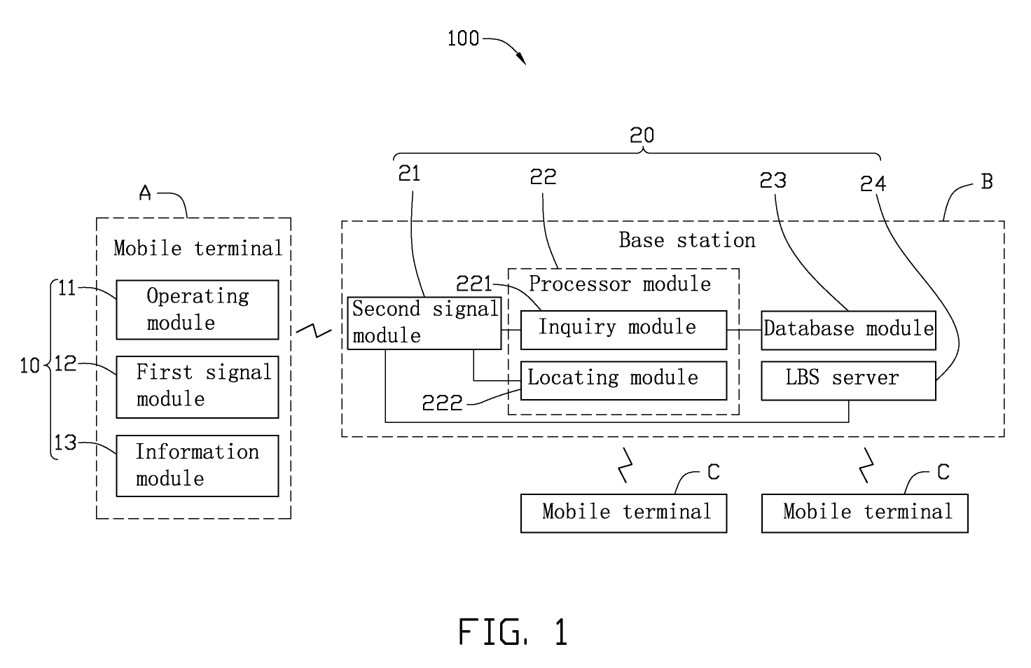

Referring to FIG. 1, a mobile terminal LBS system 100 according to an exemplary embodiment is shown. The mobile terminal LBS system 100 can be used in conventional communication networks to locate mobile terminals and provide service to the located mobile terminals. The mobile terminal LBS system 100 includes at least one mobile unit 10 and at least one service unit 20.

The mobile unit 10 is installed in a mobile terminal A, such as a mobile phone, a personal digital assistant (PDA), or a laptop computer. The mobile unit 10 includes an operating module 11, a first signal module 12 and an information module 13. The operating module 11 can be a typical operating apparatus of the mobile terminal A (e.g., a keypad or a touch panel). The user can operate the mobile unit 10 by operating the operating module 11. The first signal module 12 is a transceiver electronically connected to the operating module 11, which can be a typical transceiver of the mobile terminal A, such as an antenna. The information module 13 can be a display and/or a speaker of the mobile terminal A, which is electronically connected to the first signal module 12.

The service unit 20 is installed in a cell base station B of a wireless communication network. The service unit 20 includes a second signal module 21, a processor module 22, a database module 23, and an LBS server 24. The second signal module 21 is a transceiver for wirelessly communicating with the first signal module 12 of the mobile unit 10. The processor module 22 is a data processor connected to the second signal module 21. The processor module 22 is used to obtain information (e.g., locations, names of users, phone numbers, etc.) on other mobile terminals requested by the mobile unit 10. Particularly, the processor module 22 includes an inquiry module 221 for querying stored data of mobile terminals and a locating module 222 for locating queried mobile terminals by typical base station locating methods. The database module 23 is connected to the processor module 22 and used to store relative data (e.g., phone numbers and names of users) of mobile terminals wirelessly communicating with the base station. The LBS server 24 is connected to the processor module 22 and the second signal module 21. The LBS server 24 can transform the stored data into LBS information (e.g., short messages, images, e-mails, audio files or video files) to be sent to the mobile terminals by the second signal module 21.

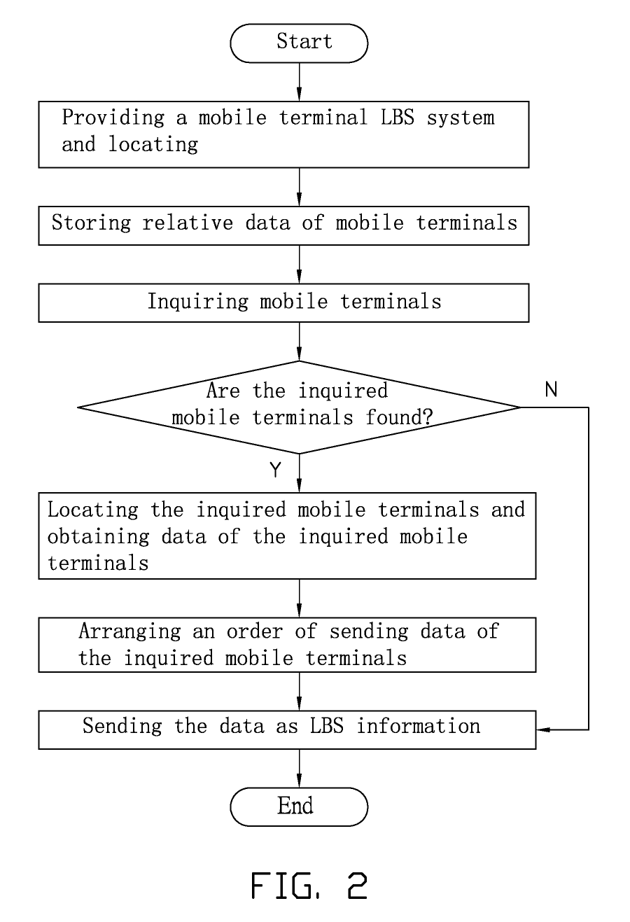

Also referring to FIG. 2, a mobile terminal locating and serving method according to an exemplary embodiment is shown. The method uses the mobile terminal LBS system 100 to locate mobile terminals and provide services to the located mobile terminals. The method includes these following steps.

First, a mobile terminal LBS system 100 is provided. As above-mentioned, the mobile unit 10 is installed in the mobile terminal A, and the service unit 20 is installed in the cell base station B. The first signal module 12 of the mobile unit 10 wirelessly communicates with the second signal module 21 of the service unit 20, thus the mobile terminal A communicates with the base station B and can be located.

Data, such as phone numbers and names of users of all mobile terminals communicating with the base station B are stored in the database module 231.

When the user of the mobile terminal A needs data on another mobile terminal C communicating with the base station B, query signals (e.g., signals to inquire about the mobile terminal C according to a predetermined phone number or name of a predetermined user) are input into the mobile unit 10 by the operating module 11. The query signals are then sent to the service unit 20 by the first signal module 12.

When the second signal module 21 receives the query signals, the locating module 222 locates the mobile terminal C, and the inquiry module 221 searches data of the mobile terminal C in the database module 23 according to the query signals. If the mobile terminal C cannot be found, the processor module 22 sends a signal as such to the mobile unit 10 via the second signal module 21. If the mobile terminal C is found and located, the LBS server 24 transforms the stored data into LBS information (e.g., short messages, images, e-mails, audio files or video files), and the second signal module 21 sends the LBS information to the first signal module 12. When the first signal module 12 receives the LBS information, the information module 13 displays the LBS information as images or character messages, and/or plays the LBS information as audio signals. Thus, the user of the mobile terminal A with the mobile unit 10 can find information on other mobile terminals (e.g., the mobile terminal C) using the mobile terminal locating system 100.

Furthermore, in the present method, query signals for data of a plurality of mobile terminals C can be input together to the mobile unit 10 by the operating module 11 and sent to the service unit 20. When receiving the query signals, the processor module 22 simultaneously searches the data of each of the plurality of mobile terminals C in the database module 23 and locates the mobile terminals C. The LBS server 24 transforms the data of the plurality of mobile terminals C into LBS information, and the second signal module 21 sends the LBS information of the plurality of mobile terminals C to the mobile unit 10 in a predetermined order, e.g., arranged according to the phone numbers of the mobile terminals or the distances between the mobile terminal A and the mobile terminals C. The LBS information received by the mobile unit 10 can be displayed/played in the same order as above.

The present mobile terminal LBS system 100 and method for using the same allow the mobile terminal A with the mobile unit 10 to inquire data of other mobile terminals C communicating with mobile terminal LBS system 100 and receive data of the mobile terminals C sent as LBS information. Thus, a plurality of mobile terminals communicating with the mobile terminal LBS 100 system can inquire data of each other.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A mobile terminal location based service (LBS) system, comprising:
at least one service unit installed in a cell base station of a wireless communicating network for wirelessly communicating with at least one mobile unit installed in a mobile terminal; wherein the service unit stores data for mobile terminals communicating with the base station; whereby when the mobile unit sends inquiry signals to the service unit for data on other mobile terminals communicating with the base station, the service unit locates the inquired mobile terminals and sends the data of the inquired mobile terminals to the mobile unit as LBS information.

2. The mobile terminal LBS system as claimed in claim 1, wherein the mobile unit includes an operating module for operating the mobile unit and a first signal module electronically connected to the operating module for sending inquiry signals and receiving data on the inquired mobile terminal.

3. The mobile terminal LBS system as claimed in claim 2, wherein the mobile unit further includes an information module electronically connected to the first signal module for displaying or playing data the inquired mobile terminal received by the first signal module.

4. The mobile terminal LBS system as claimed in claim 2, wherein the service unit includes a second signal module communicating with the first signal module, a processor module connected to the second signal module to obtain information on mobile terminals inquired by the mobile unit, a database module connected to the processor module for storing relative data of mobile terminals communicating with the base station, and an LBS server connected to the processor module and the second signal module for transforming data on the inquired mobile terminal into LBS information.

5. The mobile terminal LBS system as claimed in claim 4, wherein the processor module includes an inquiry module for inquiring stored data about mobile terminals and a locating module for locating inquired mobile terminals.

6. A method for locating and serving mobile terminals, comprising these steps:
providing a mobile terminal LBS system including at least one mobile unit installed in a mobile terminal and at least one service unit installed in a base station of a wireless communication network;
storing relative data of mobile terminals communicating with the base station in the service unit;
using the mobile unit to send inquiry signals for data on other mobile terminals communicating with the base station to the service unit;
using the service unit to locate the inquired mobile terminal and obtain data on the inquired mobile terminal; and
using the service unit to transform the data into LBS information and sending the LBS information to the mobile unit.

7. The method as claimed in claim 6, further comprising using the service unit to locate the mobile unit.

8. The method as claimed in claim 6, further comprising displaying and/or playing the LBS information by the mobile unit when the mobile unit receives the LBS information.

9. The method as claimed in claim 6, further comprising sending inquiry signals to inquire data of a plurality of mobile terminal communicating with the base station to the service unit, locating the mobile terminals and obtaining data on the mobile terminals, transforming the data into LBS information and sending the LBS information to the mobile unit.

10. The method as claimed in claim 9, wherein the LBS information of the plurality of mobile terminals is sent to the mobile unit and displayed/played in an order arranged according to the phone numbers of the plurality of mobile terminals.

11. The method as claimed in claim 9, wherein the LBS information of the plurality of mobile terminals is sent to the mobile unit and displayed/played in an order arranged according to the distances between the mobile unit and the plurality of mobile terminals.
